(19) United States
(12) Patent Application Publication
(10) Pub. No.: US 2008/0267034 A1
(43) Pub. Date: Oct. 30, 2008

(54) (Re) Writable Disk with Electrophoetic Ink Label

(75) Inventors: Guofu Zhou, Eindhoven (NL); Anthonie Hendrik Bergman, Eindhoven (NL); Frank Cornelis Penning, Eindhoven (NL); Mark Thomas Johnson, Eindhoven (NL); Wilhelmus Franciscus Johannes Fontijn, Eindhoven (NL); Steven Broeils Luitjens, Eindhoven (NL); Michael Adrianus Henricus Van Der Aa, Eindhoven (NL); Murray Fulton Gillies, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,601

(22) PCT Filed: Mar. 31, 2005
(86) PCT No.: PCT/IB2005/051075

§ 371 Date: Oct. 3, 2006

(30) Foreign Application Priority Data
Apr. 7, 2004 (EP) 04101440.8

(51) Int. Cl. G11B 3/74

(52) U.S. Cl. 369/94

(57) ABSTRACT

A storage medium for storing digital information is disclosed. The storage medium comprises a label comprising a light addressable electrophoretic ink layer. Further, a method for labeling a storage medium provided with an electrophoretic ink label is disclosed. The method comprises the steps of applying a voltage between a first and a second electrode being arranged on mutual sides of a electrophoretic ink layer; irradiating selected pixel areas of the electrophoretic ink for addressing a change of visual state. Further, a recorder for an optical storage medium and a label writer for labeling an optical storage medium are disclosed. The recorder and the label writer comprise a light source and a charging device. The charging device is arranged to apply an electric field across an electrophoretic ink layer of the storage medium, and the light source is arranged to write a label on said storage medium by addressing pixel areas of said electrophoretic ink layer.

### FIELD OF INVENTION

The present invention relates to a storage medium for storing digital information, a method for labeling the storage medium, and a printer for the storage medium.

### BACKGROUND OF INVENTION

It is known, that digital information can be stored in different storage media, e.g. an optical disc, such as a compact disc (CD), a digital versatile disc (also called digital video disc, DVD), or a blue-ray disc, e.g. portable blue. It is also known, that information can be stored in these storage media by means of different user equipment, e.g. a CD burner.

To keep track of what information that is stored on a certain CD or DVD, some kind of labeling is needed. A CD or DVD is formed such that one side of the disc is dedicated for the stored information, and the other can be used for labeling, and will therefore be referred to as labeling side.

There are several ways to label a disc. One is of course to use a soft tip pen and write some notes on the labeling side. Another way is to use some kind of stickers that are placed on the labeling side. A third way is provided by some printers, which have the feature of printing directly on the labeling side of the disc. Each of these has their disadvantages. Often, handwritten notes do not look good, and it may be difficult to fit in all information needed on the limited area of the disc. Stickers specially suited for CDs and DVDs are many times as expensive as the disc itself. There is also a risk with these stickers. They may peel off, and can then cause damage to the disc drive, since the disc rotates with a high speed when reading the stored information. A printer with labeling printing features adds equipment costs.

All of the above mentioned ways of labeling storage media mentioned have one disadvantage in common. There are different types of storage media, and some of them are re-writable. As the user re-writes the storage medium with new information, the user also wants to re-write the label so that it corresponds to the contents of the storage medium. Therefore, the above presented ways of labeling re-writable storage media present a problem in that the label is more or less permanent.

### SUMMARY OF THE INVENTION

It is therefore an object of the invention to at least partly overcome the above stated problems and disadvantages.

The above object, together with other objects, which will become evident from the detailed description below, are obtained according to a first aspect of the present invention by an optical storage medium for storing digital information comprising an optical storage layer. The optical storage medium further comprises a label comprising an electrophoretic ink layer, wherein the electrophoretic ink is light addressable.

The term “electrophoretic ink” means any material which can change its visual appearance by electrophoresis.

The term “light addressable” means that selected areas of the electrophoretic ink layer can be locally written by modulating either the intensity or duration of the applied light to the pixel areas. Addressing selected areas by light can thus produce the label. An advantage of this is that a label can be written by irradiation. Another advantage is that the properties of the electrophoretic ink layer enable re-writing of the label.

The label may further comprise a photoconductive layer. The photoconductive layer may be located between the electrophoretic ink layers and a layer for storing the digital information. Alternatively, the photoconductive layer may be located between the electrophoretic ink layer and a label side of the storage medium. The photoconductive layer provides ability to control the local electric field over the electrophoretic field by irradiation, i.e. for each pixel area.

The light addressable electrophoretic ink layer may have heat dependent switching time, such that a visual state of the electrophoretic ink changes upon heating by irradiation and applying an electric field. The heat dependent switching time provides ability to control switching of the visual state by irradiation.

The electrophoretic ink may be arranged to be irradiated by a laser for addressing the electrophoretic ink. The laser may also be used for recording digital information on the storage medium. This enables an integrated and compact solution.

The storage medium may comprise a first electrode, a second electrode, and a voltage applying means for applying a voltage between the first and second electrodes. Electrodes integrated in the storage medium enable provision of an electric field with appropriate strength at lower voltages. The voltage applying means may comprise a receiver for radio-frequency signals, a circuit for transforming the radio frequency signal into a voltage, wherein said circuit is arranged to apply the voltage between the first and second electrodes. This enables wireless application of supply voltage. Alternatively, the voltage applying means may comprise external contacts to apply the voltage between the first and second electrodes. This enables voltage supply to the electrodes.

The electrophoretic ink may comprise electrophoretic ink microcapsules, SiPix microcups, or gyricon spheres, or any combination thereof.

A product of a resistance and a capacitance of the electrophoretic ink layer may preferably be higher than 0.001° F./m², and preferably higher than 0.004° F./m². For example, R_{photoconductor}*C_{photoconductor}≈10MΩ*5 μF per m², and Rᵢₙₖ*Cᵢₙₖ≈20 kΩ*0.2 μF per m². This enables high speed writing, since a short light pulse will give a remaining increased voltage over the electrophoretic ink layer for a longer time, which will enable switching of the visual state of the irradiated pixel area even with very short exposure by the addressing light.

The above object, together with other objects, which will become evident from the detailed description below, are obtained according to a second aspect of the present invention by a method for labeling an optical storage medium provided with a label comprising an electrophoretic ink layer, comprising the steps of:

applying a voltage between a first and a second electrode, said electrodes being arranged on mutual sides of the electrophoretic ink layer;

irradiating selected pixel areas of the label for addressing a change of visual state.

The term “visual state” means the visual appearance of each pixel area of the electrophoretic ink which is visible to a viewer. Each pixel area of the electrophoretic ink has two extreme visual states and the possibility to form grey levels between these states.

This enables label writing with a light source. The use of electrophoretic ink provides non-permanent labeling on demand.

The method may further comprise the step of initialising the electrophoretic area by making it uniform in terms of visual state. The step of initialising may comprise the step of applying a uniform electric field for a predetermined time period. Preferably the step of initialising may comprise the step of applying a changing voltage across the electrodes. Thereby, a capacitive voltage division between a photoconductor and an electrophoretic layer is achieved due to their capacitances and the changing voltage, which results in an electric field over the electrophoretic material strong enough to put the electrophoretic ink into a uniform visual state, even with a moderate applied voltage.

The changing voltage may change from one value to a voltage of the opposite polarity. The voltage of the opposite polarity may be of the same magnitude.

The method may further comprise a step of initialising comprising the steps of:

applying a square wave voltage between the electrodes to cause capacitive voltage splitting between a photoconductive layer and the electrophoretic ink layer for erasing an existing label;

applying a ramp voltage between the electrodes to cause a resistive voltage splitting between the photoconductive layer and the electrophoretic ink layer, wherein the ramp voltage is a predetermined voltage for suited for label writing at the end of the ramp; and

applying the predetermined voltage between the electrodes during a time period for writing the label.

These initialising methods provide improved re-writing.

The step of irradiating selected pixel areas may comprise heating the electronic ink of the pixel areas. This enables using temperature dependent properties of the electrophoretic ink for addressing the pixel areas and/or increasing writing speed.

The step of applying the voltage between the first and second electrodes may comprise the steps of: generating a radio-frequency signal; transmitting the radio-frequency signal to the optical storage medium; receiving the radio-frequency signal at the storage medium; transforming the received radio-frequency signal to a voltage; and applying the voltage between the first and second electrodes.

The step of applying the voltage between the first and second electrodes may comprise the step of supplying a voltage to the optical storage medium through a connector.

The above object, together with other objects, which will become evident from the detailed description below, are obtained according to a third aspect of the present invention by a recorder for an optical storage medium, comprising a first light source for recording digital information on an optical storage layer of the storage medium, a second light source for writing a label comprising an electrophoretic ink layer of the optical storage medium, and a means for applying an electric field across the electrophoretic ink layer.

This enables an attractive device for integrated recording and label writing. The use of electrophoretic ink enables re-writing the label when the recorded information changes.

The first and second light sources may be one common light source. This saves space and costs.

The above object, together with other objects, which will become evident from the detailed description below, are obtained according to a fourth aspect of the present invention by a label writer for an optical storage medium, comprising a light source for writing a label comprising an electrophoretic ink layer of the optical storage medium, and a means for applying an electric field across the electrophoretic ink layer. The label writer may comprise a positioning means arranged to fit into a center hole of the optical storage medium and a position sensor arranged to provide a position of the label writer in relation to the optical storage medium, wherein the label writer is hand operated.

A particular feature of the present invention is the ability to write and re-write labels on an optical storage medium for digital information.

A particular advantage of the present invention is provision of freedom to change the content of the label of the storage medium. This is a significant advantage when the storage medium is re-writable in sense of the digital information.

### BRIEF DESCRIPTION OF THE DRAWINGS

FIG. 1 shows a media storage disc.

FIG. 2 is a cross section view of a part of a media storage disc.

FIG. 3 is a schematic view of an electrophoretic ink layer according to an embodiment of the invention.

FIG. 4 is a cross section view of a part of a storage medium according to an embodiment of the present invention.

FIG. 5 is a cross section view of a part of a storage medium according to another embodiment of the present invention.

FIG. 6 is a cross section view of a part of a storage medium according to further another embodiment of the present invention.

FIG. 7 shows a chart with voltage between the electrodes over time during initialisation and writing.

FIG. 8 shows a recorder for an optical storage medium capable of recording data and writing a label

FIG. 9 shows a writer for labeling an optical storage medium.

FIGS. 10a and 10b show a label writer according to an embodiment of the present invention.

### DETAILED DESCRIPTION OF THE PREFERRED EMBODIMENTS

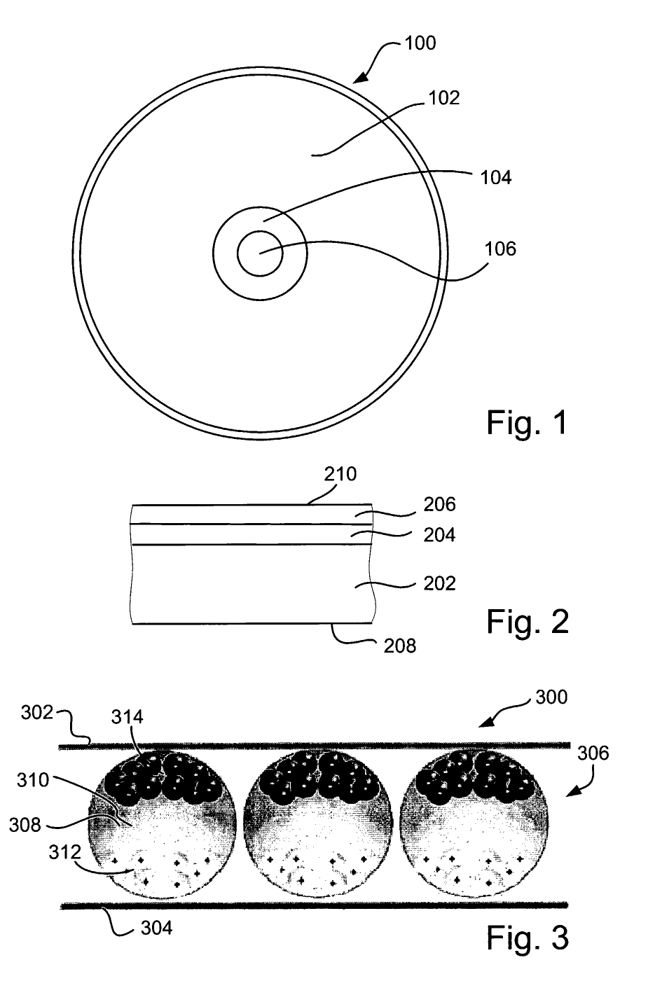

FIG. 1 shows a media storage disc 100, preferably an optical disc such as a CD, a DVD, or a blue-ray disc, which have a field 102 encircling a center part 104 provided with a hole 106. FIG. 2 shows a part of the field 102 of FIG. 1 in cross section, showing a transparent substrate layer 202, a layer for recording information 204, and a protective layer 206. The digital information is read and written from a media access side 208, and the protective layer 206 is suited for labeling the disc, and therefore has a labeling side 210.

The present invention is based on the understanding that a storage media would benefit from a re-writable label. This is to an even larger extent applicable for a storage media capable of changing its stored digital content. The present invention is also based on the further understanding that an electrophoretic ink layer can be used for a re-writable label.

FIG. 3 schematically shows the principle for an electrophoretic ink layer 300, which is based on an electrophoretic technology. The electrophoretic ink layer comprises a transparent front electrode 302 and a back electrode 304. Here, the expression “front” is used to denote the side that is exposed to a viewer, and the expression “back” for the opposite side. The number of electrodes used at front and back sides are arbitrary. Between the electrodes 302, 304, an electrophoretic ink material, e.g. a plurality of electrophoretic ink microcapsules 306 are provided. A microcapsule 308 comprises a clear fluid 310. Charged particles 312 with a first colour are suspended in the clear fluid 310. Other particles 314 with a second colour, and opposite charge are also suspended in the clear fluid 310. An example is positively charged white particles and negatively charged black particles, as depicted in FIG. 3, to provide black or white appearance to a viewer, who is watching the microcapsules 306 through the transparent front electrode 302. Other combinations of colours and charge are possible to get other visual effects. The visual effects are achieved by applying an electric field between the electrodes 302, 304, and depending on the orientation of the electric field, the particles with the first or the second colour will appear at the front of the microcapsule 308. The microcapsules 306 are bi-stable, and if the electric field is removed, the visual appearance remains.

Different parts of a microcapsule can be exposed to different electrical fields. Therefore, a first part of positively charged particles of a first colour will appear on a first part of the front of the microcapsule, and the second part of the positively charged particles will be at a second back part of the microcapsule. Thus, a first part of negatively charged particles of a second colour will appear on a second part of the front of the microcapsule, and the second part of the negatively charged particles will be at a first back part of the microcapsule.

For applying the electric fields, one way would be to control voltages of an electrode grid, another way would be to use an active matrix for addressing the visual states of the electrophoretic ink. However, these technologies would be too costly, too bulky, and need a power source in the storage medium. Instead, the present invention has a common back electrode and a common front electrode for the entire electrophoretic area, or for a larger part of it. The addressing of the electrophoretic ink is made by light, as will be described below.

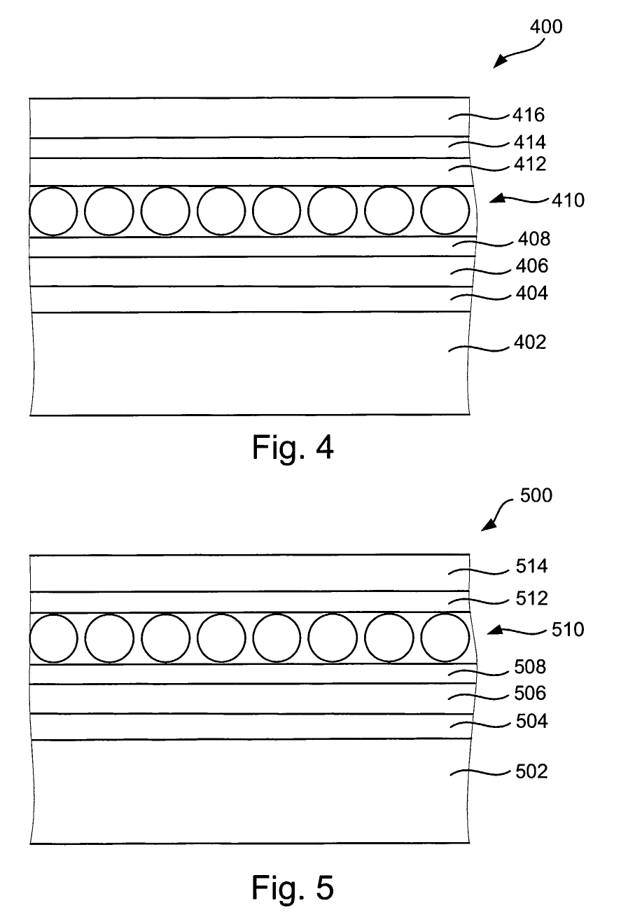

FIG. 4 shows a cross section of an optical storage medium 400 according to one embodiment of the invention. The storage medium 400 comprises a transparent substrate 402, a layer for recording medium 404, a protective layer 406, a back electrode 408, a plurality of microcapsules 410, a photoconductive layer 412, a transparent front electrode 414, and a protective layer 416. Here, the expression “front” is used to denote the side that is exposed to a viewer, and the expression “back” for the opposite side. Electrophoretic ink microcapsules are here used as an illustrative example, but any electrophoretic ink material would be applicable. By applying a voltage between the electrodes 408, 414, as will be described below, and irradiating the photoconductive layer 412 on selected pixel areas, the microcapsules 410 are selectively and optically addressed to change states. This is achieved by the voltage between the electrodes 408, 414, which produces an electric field across the plurality of microcapsules. However, this electric field is too weak to change the states of the microcapsules, but when the selected pixel area of the photoconductive foil 412 is irradiated, it starts conducting on that spot, which lowers the local resistance of the photoconductor layer. The division of applied voltage then shifts in the illuminated pixel area so that a larger fraction is dropped over the electrophoretic material rather than the photoconductor. Given that a sufficient decrease in resistance is obtained, the increased electric field over the electrophoretic layer is strong enough to change the visual state of the pixel area in the electrophoretic layer.

If the RC of the system is chosen to create a long decay constant, this allows a voltage over the E-ink to be sustained for a relatively long period of time with regard to a short light pulse. For example, a light pulse of 1 ms produces an increased voltage over the electrophoretic ink for a period in the order of 1 second. This enables fast writing, i.e. short light pulses.

The time a microcapsule needs to change its appearance from one colour to another is temperature dependent. This is disclosed in WO 03/100758 A1, which discloses temperature compensation for electrophoretic display panels. A low temperature implies a longer switch time than a high temperature. An example from a test is that a temperature increase from room temperature to 60 degrees centigrade will decrease switch time by about 50%. Another example from another test is that a temperature increase from room temperature to 70 degrees centigrade will improve switching speed by a factor of three.

FIG. 5 shows a cross section of an optical storage medium 500 according to another embodiment of the invention. The storage medium 500 comprises a transparent substrate 502, a layer for recording medium 504, a protective layer 506, a back electrode 508, a plurality of microcapsules 510, a transparent front electrode 512, and a protective foil 514.

Here, the expression “front” is used to denote the side that is exposed to a viewer, and the expression “back” for the opposite side. Electrophoretic ink microcapsules are here used as an illustrative example, but any electrophoretic ink material would be applicable. When a spot of the electrophoretic material, i.e. the microcapsules 510, are irradiated, the temperature of the microcapsules is increased. By heating the microcapsules 510 on selected pixel areas this way, and applying a voltage between the electrodes 508, 512, the microcapsules 510 are selectively and optically addressed to change states according to the generated electric field and the applied heat. Since the temperature dependent switching time of the electrophoretic material is utilized, the electric field between the electrodes 508, 512 is only applied for a short time. The time is too short to enable a change of state during the short time in e.g. room temperature, but a change of state is enabled at the selected irradiated and thus heated pixel areas.

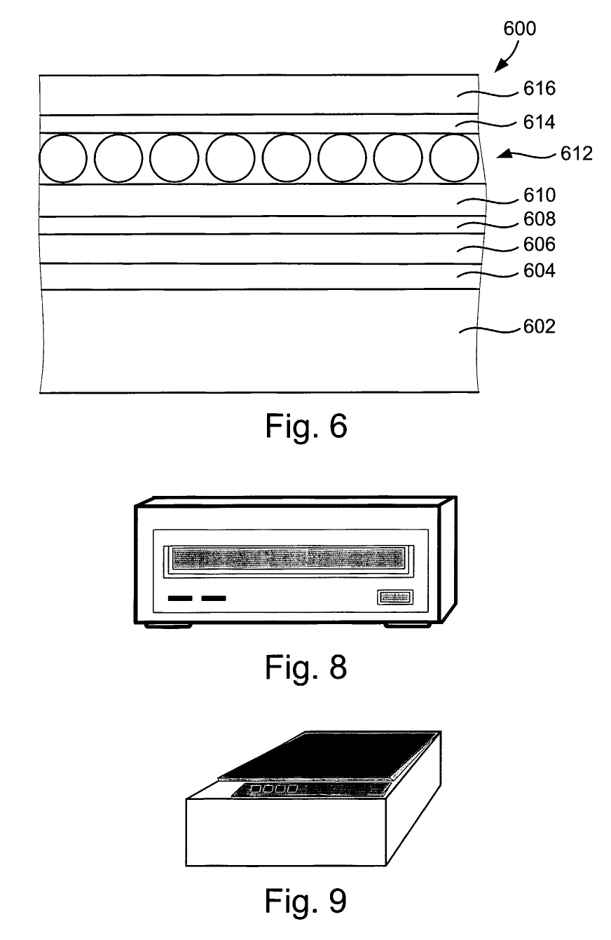

FIG. 6 shows a cross section of an optical storage medium 600 according to another embodiment of the invention. The storage medium 600 comprises a transparent substrate 602, a layer for recording medium 604, a protective layer 606, a back electrode 608, a photoconductive layer 610, a plurality of microcapsules 612, a transparent front electrode 614, and a protective foil 616. Here, the expression “front” is used to denote the side that is exposed to a viewer, and the expression “back” for the opposite side. Electrophoretic ink microcapsules are here used as an illustrative example, but any electrophoretic ink material would be applicable. By irradiating the photoconductive foil 610 on selected pixel areas and applying a voltage between the electrodes, the microcapsules 612 are selectively and optically addressed to change states according to the locally generated electric field as the photoconductive foil 610 starts conducting on the irradiated pixel areas. The difference between this embodiment and the embodiment shown in FIG. 4 is that the photoconductive foil 610 is less visible from the labeling side, and does therefore not interfere with the visual properties of the label.

Both embodiments as depicted in FIG. 4 and FIG. 6 can be written from both sides of the disc. This is because electrophoretic ink layer is 10-15% transparent to laser light. If the embodiment of FIG. 6 is written from the media access side, e.g. with the disc-drive laser, more light will reach the photoconductive layer than that of FIG. 4. Faster writing is thus provided. If the embodiment of FIG. 6 is used, the Ag mirror layer (not shown), which is behind the active recording layer, should be made more transparent than usual to allow some light through to address the photoconductor. Optionally, a label writing power above the normal CD or DVD recorder laser power is used, and label writing is performed before the data recording. An advantage of this is that irradiation can be made from the same side as the irradiation for storing digital information to the optical disc.

According to a further embodiment of the present invention, both a photoconductive foil and heating of the microcapsules is used to address selected pixel areas. By irradiating the photoconductive layer on selected pixel areas, and applying a voltage between the electrodes, the microcapsules are selectively and optically addressed to change states according to the local electric field as the photoconductive layer starts conducting on the irradiated pixel areas, as in the embodiment shown in FIG. 4. At the same time, the microcapsules are heated by the irradiation, as in the embodiment shown in FIG. 5, on the same pixel areas, thus decreasing their switching time. This combination of effects will further increase label writing speed.

In all of the above presented embodiments, the label writing can be performed either in a separate device, or, preferably, in the same device as is used for recording digital information on the storage medium.

The light source for addressing the electrophoretic ink can be a dedicated light source, or be the same as is used for recording digital information on the storage medium. The light source is preferably, in any case, a laser, but can also be a light emitting diode (LED).

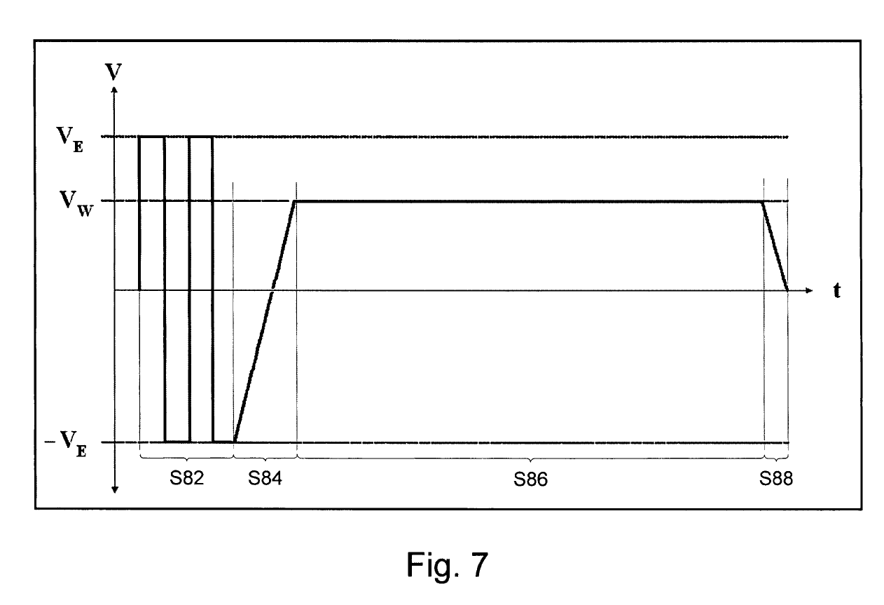

A process for labeling a storage medium provided with electrophoretic ink is performed in a number of steps. For better understanding the physical properties of the steps described below, FIG. 7 shows a chart with voltage between the electrodes over time during initialisation and writing, by example only. S82 is an erasing period, where the gradient of the change in voltage is chosen to be steep enough in order to cause capacitive voltage splitting rather than resistive voltage splitting between the electrophoretic ink layer and the photoconductive layer. S84 is a slow voltage ramp period where the gradient is chosen low enough to cause resistive voltage splitting and avoid capacitive voltage splitting between the electrophoretic ink layer and the photoconductive layer. S86 is a period when the label can be addressed, i.e. the writing period. The voltage ramp S88 at the end is also preferable to avoid erasing the label. The exact values of the gradients depend on the properties of the photoconductor and the electrophoretic ink.

A first step is to initialise the whole electrophoretic ink area by e.g. applying a uniform electric field for a relative long time period, e.g. 1 to 10 s, preferably 2 to 5 s, preferably 3 s. This initialisation will provide a uniformly coloured state of the electrophoretic ink. However, preferably a fast changing voltage, e.g. a square wave voltage, is applied across the electrodes, to get a voltage division between photoconductor and electrophoretic layer due to their capacitances. The changing voltage will enable this capacitive voltage division. Thus is an electric field achieved across the electrophoretic material for putting it into a uniform visual state.

A second step is to apply a voltage to the stack that will enable a change of state of the electrophoretic ink in next step. This voltage is in the form of a slow ramp to a voltage of opposite polarity.

A third step is to irradiate the parts of the electrophoretic ink area that should be changed in colour.

A fourth step is to remove the electric field with a slow ramp to avoid erasing the written image. The bi-stable properties of the electrophoretic ink will ensure that the created text and/or picture is maintained.

The step of irradiating the parts of the electrophoretic ink can comprise heating the ink to enable a change in colour, or making a photoconductive layer conductive to enable a change in colour, or a combination thereof.

According to one embodiment of the present invention, the irradiation is performed as a single laser pulse at every pixel area that should change colour.

According to a further embodiment of the invention, the irradiation is performed as a plurality of short laser pulses. This will decrease heat accumulation and diffusion in the electrophoretic ink, which will result in higher contrast ratio and higher resolution. However, image writing speed may be decreased, but this can be compensated by e.g. increased voltage between the electrodes.

The steps of applying an electric field on the electrophoretic ink comprises charging a capacitor connected between the electrodes of the electrophoretic layer. The capacitor is preferably charged by a device performing the label printing, and the capacitor can be integrated in the storage medium. The capacitor is preferably connected to the device via connectors. The capacitor is connected to the electrodes during the writing period and not during the erasing period. Alternatively, the capacitor is charged by a radio frequency (RF) device, which is embedded in the disc, and an embedded circuit. Thus, energy is transmitted from an RF device of the device performing the label writing to the RF device of the storage medium. The RF device of the storage medium comprises an RF receiver and a circuit. The circuit generates a voltage that is applied to the capacitor. Thus, the capacitor is charged, and as the capacitor is coupled between the electrodes, which are arranged on mutual sides of the electrophoretic layer, as described in the above embodiments, an electrical field can be achieved across the electrophoretic layer. The capacitance of the capacitor is preferably a couple of tens of microfarads for a disc of the size of a CD. The circuit can also apply a fast changing voltage between the electrodes.

The step of initialising the electrophoretic ink of the disc is preferably made while manufacturing the storage medium the first time it is performed, i.e. the label of the storage medium is pre-initialised, and in the device for labeling the disc when a label is to be re-written. The step of initialising can comprise irradiating the entire disc and/or heating the entire disc.

According to a further embodiment, the writing process comprises applying an electric field on the electrophoretic ink that will enable a change of state of the electrophoretic ink in an irradiation step. The parts of the electrophoretic ink area that should be changed in colour are then irradiated in the irradiation step. A final step is to remove the electric field. Changes are in this manner added to current text or image of the label.

FIG. 8 shows a recorder for an optical storage medium. The recorder comprises a light source, preferably a laser, for reading/writing stored digital information from/to an optical storage medium. The optical storage medium can be an optical disc, such as a compact disc (CD), a digital versatile disc (also called digital video disc, DVD), or a blue-ray disc, e.g. portable blue. The recorder further comprises a light source for printing a label on the optical storage medium by irradiating selected pixel areas of an electrophoretic ink layer of the optical storage medium as described above. The recorder also comprises means for applying an electric field across the electrophoretic ink layer. The means can be a voltage source which connects to the optical storage medium via connectors, or an RF device transmitting power to the storage medium via RF signals.

FIG. 9 shows a writer for labeling an optical storage medium. The optical storage medium can be an optical disc, such as a compact disc (CD), a digital versatile disc (also called digital video disc, DVD), or a blue-ray disc, e.g. portable blue. The writer comprises a light source for writing a label on the optical storage medium by irradiating selected pixel areas of an electrophoretic ink layer of the optical storage medium as described above. The writer also comprises means for applying an electric field across the electrophoretic ink layer. The means can be a voltage source which connects to the optical storage medium via connectors, or an RF device transmitting power to the storage medium via RF signals.

A product of a resistance and a capacitance of the electrophoretic ink layer is preferably high. For example, R_{photoconductor}*C_{photoconductor}≈10 MΩ*5 μF per m², Rᵢₙₖ*Cᵢₙₖ=20 kΩ*0.2 μF per m². This enables high speed writing, since a short light pulse will give a remaining increased voltage over the electrophoretic ink layer for a longer time, which will enable switching of the visual state of the irradiated pixel area even with very short exposure by the addressing light.

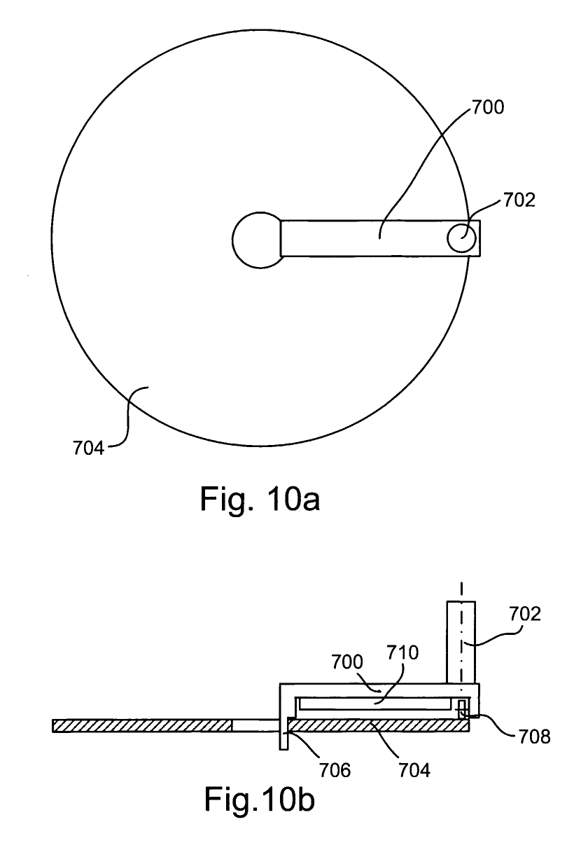

FIGS. 10a and 10b show a further embodiment of a label writer 700. The label writer 700 is provided with a handle 702. Writing is performed by applying the label writer 700 to an optical storage medium 704 and rotating the label writer 700 over the optical storage medium 704 by pushing the handle 702. A positioning means 706 is fitted into the center hole of the optical storage medium 704, and a position sensor 708, e.g. a wheel, will give an angle position during the rotation of the label writer 700. The angle position is used to correctly address the electrophoretic ink, which is irradiated by a light source 710, preferably a laser or a LED device. A voltage is supplied to the optical storage medium 704 by a voltage supply (not shown). This is preferably done by contact means, which is suitable since the optical storage medium 704 is stationary during writing the label.

1. An optical storage medium for storing digital information, said storage medium comprising an optical storage layer (404, 504, 604) and a label, wherein said label comprises an electrophoretic ink layer (410, 510, 612), wherein said electrophoretic ink is light addressable.

2. Optical storage medium according to claim 1, wherein said label further comprises a photoconductive layer (412, 610).

3. Optical storage medium according to claim 2, wherein said photoconductive layer (412, 610) is located between said electrophoretic ink layer (410, 612) and the optical storage layer (404, 604).

4. Optical storage medium according to claim 2, wherein said photoconductive layer (412, 610) is located between said electrophoretic ink layer (410, 612) and a label side of said storage medium.

5. Optical storage medium according to claim 1, wherein said light addressable electrophoretic ink layer (410, 510, 612) has heat dependent switching time, such that a visual state of said electrophoretic ink changes upon heating by irradiation and applying an electric field.

6. Optical storage medium according to claim 1, wherein said label is arranged to be irradiated by a laser for addressing said electrophoretic ink.

7. Optical storage medium according to claim 6, wherein said laser also is used for recording digital information on said optical storage medium.

8. Optical storage medium according to claim 1, comprising a first electrode (408, 508, 608), a second electrode (414, 512, 614), and a voltage applying means for applying a voltage between said first and second electrodes (408, 414, 508, 512, 618, 614).

9. Optical storage medium according to claim 8, wherein said voltage applying means comprises a receiver for radio frequency signals, a circuit for transforming said radio-frequency signal into a voltage, wherein said circuit is arranged to apply said voltage between said first and second electrodes (408, 414, 508, 512, 618, 614).

10. Optical storage medium according to claim 8, wherein said voltage applying means comprises external contacts to apply said voltage between said first and second electrodes (408, 414, 508, 512, 618, 614).

11. Optical storage medium according to claim 1, wherein said electrophoretic ink comprises electrophoretic ink microcapsules, SiPix microcups, or gyricon spheres, or any combination thereof.

12. Optical storage medium according to claim 1, wherein a product of a resistance and a capacitance per area unit of said electrophoretic ink layer (410, 510, 612) is higher than 0.001 ΩFm⁻², and preferably higher than 0.004 ΩFm⁻².

13. A method for labeling an optical storage medium provided with a label comprising an electrophoretic ink layer (410, 510, 612), comprising the steps of:
applying a voltage between a first and a second electrode (408, 414, 508, 512, 618, 614), said electrodes (408, 414, 508, 512, 618, 614) being arranged on mutual sides of said electrophoretic ink layer (410, 510, 612);
irradiating selected pixel areas of said label for addressing a change of visual state.

14. Method according to claim 13, further comprising the step of initialising said electrophoretic ink layer (410, 510, 612) by making it uniform in terms of visual state.

15. Method according to claim 14, wherein said step of initialising comprises the step of applying a uniform electric field for a predetermined time period.

16. Method according to claim 14, wherein said step of initialising comprises the step of applying a changing voltage across said electrodes (408, 414, 508, 512, 618, 614).

17. Method according to claim 13, further comprising a step of initialising, comprising the steps of:
applying a square wave voltage between said electrodes (408, 414, 618, 614) to cause capacitive voltage splitting between a photoconductive layer (412, 610) and said electrophoretic ink (410, 612) layer for erasing an existing label;
applying a ramp voltage between said electrodes (408, 414, 618, 614) to cause resistive voltage splitting between said photoconductive layer and said electrophoretic ink layer (412, 610), wherein said ramp voltage is a predetermined voltage suited for label writing in the end of said ramp; and
applying said predetermined voltage between said electrodes (408, 414, 618, 614) during a time period for writing said label.

18. Method according to claim 13, wherein said step of irradiating selected pixel areas comprises heating the electrophoretic ink of said pixel areas.

19. Method according to claim 13, wherein said step of applying said voltage between said first and second electrodes (408, 414, 508, 512, 618, 614) comprises the steps of:
generating a radio-frequency signal;
transmitting said radio-frequency signal to said optical storage medium;
receiving said radio-frequency signal at said storage medium;
transforming said received radio-frequency signal to a voltage; and
applying said voltage between said first and second electrodes (408, 414, 508, 512, 618, 614).

20. Method according to claim 13, wherein said step of applying said voltage between said first and second electrodes (408, 414, 508, 512, 618, 614) comprises the step of supplying a voltage to said optical storage medium through a connector.

21. A recorder for an optical storage medium, comprising a first light source for recording digital information on an optical storage layer (404, 504, 604) of said storage medium, a second light source for writing a label comprising an electrophoretic ink layer (410, 510, 612) of said storage medium by addressing pixel areas of said electrophoretic ink layer (410, 510, 612), and a means for applying an electric field across said electrophoretic ink layer (410, 510, 612).

22. Recorder according to claim 21, wherein said first and second light sources are one common light source.

23. A label writer for labeling an optical storage medium, comprising a light source for writing a label comprising an electrophoretic ink layer (410, 510, 612) of said storage medium by addressing pixel areas of said electrophoretic ink layer (410, 510, 612), and a means for applying an electric field across said electrophoretic ink layer (410, 510, 612).

24. Label writer according to claim 23, comprising a positioning means (706) arranged to fit into a center hole of said optical storage medium (704) and a position sensor (708) arranged to provide a position of said label writer (700) in relation to said optical storage medium (704), wherein said label writer (700) is hand operated.
